(19) United States
(12) Patent Application Publication
(10) Pub. No.: US 2024/0357626 A1
(43) Pub. Date: Oct. 24, 2024

(54) WIRELESS TELECOMMUNICATIONS APPARATUSES AND METHODS

(71) Applicant: Sony Group Corporation, Tokyo (JP)

(72) Inventors: Martin Warwick BEALE, Basingstoke (GB); Shin Horng WONG, Basingstoke (GB); Basuki PRIYANTO, Basingstoke (GB)

(73) Assignee: Sony Group Corporation, Tokyo (JP)

(21) Appl. No.: 18/684,186

(22) PCT Filed: Jul. 7, 2022
(86) PCT No.: PCT/EP2022/068920

§ 371 Date: Feb. 16, 2024

(30) Foreign Application Priority Data
Aug. 23, 2021 (EP) 21192674.6

(51) Int. Cl. H04W 72/51; H04W 72/04

(52) U.S. Cl. CPC H04W 72/51; H04W 72/04

(57) ABSTRACT

A first wireless telecommunications apparatus comprising: communication circuitry configured to receive wireless signals from or transmit wireless signals to a second wireless telecommunications apparatus, the communication circuitry using energy stored in an energy storage device to receive or transmit the wireless signals; and control circuitry configured to: determine a characteristic associated with the energy stored in the energy storage device: control the communication circuitry to transmit information indicating the determined characteristic to the second wireless telecommunications apparatus.

### BACKGROUND

### Field of the Disclosure

The present disclosure relates to wireless telecommunications apparatuses and methods.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Recent generation mobile telecommunication systems, such as those based on the 3^{rd} Generation Partnership Project (3GPP®) defined Universal Mobile Telecommunications System (UMTS), Long Term Evolution (LTE) and 5G New Radio (NR) architectures, are able to support a wider range of services than simple voice and messaging services offered by previous generations of mobile telecommunication systems. For example, with the improved radio interface and enhanced data rates provided by LTE and NR systems, a user is able to experience high data rate applications such as mobile video streaming and mobile video conferencing that would previously only have been available via a fixed line data connection. In addition to supporting these kinds of more sophisticated services and devices, it is also proposed for newer generation mobile telecommunication systems such as NR to support less complex services and devices which make use of the reliable and wide ranging coverage of newer generation mobile telecommunication systems without necessarily needing to rely on the high data rates available in such systems. For example, a less complex device may be a tiny device equipped with sensors and a small battery capacity. Such a less complex device needs to transmit the sensor data at a typically infrequent and/or low data rate.

The demand to deploy such networks is therefore strong and the coverage area of these networks, i.e. geographic locations where access to the networks is possible, may be expected to increase ever more rapidly. There is also a continuing need to improve the network speed, reliability, efficiency and/or flexibility of these networks. In particular, there is a need to ensure entities of a network are provided with sufficient energy to communicate with the network, are able to use that energy efficiently, and are able to use radio resources efficiently.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically represents some elements of an LTE-type wireless telecommunications system;

FIG. 2 schematically represents some elements of an NR-type wireless telecommunications system;

FIG. 3 schematically represents some components of the wireless telecommunications system shown in FIG. 2 in more detail;

FIG. 4 schematically further represents some elements of an NR-type wireless telecommunications system;

FIG. 5 schematically represents energy flows on a device using harvested energy;

FIG. 6 schematically represents a first example of the charge state of a device;

FIG. 7 schematically represents a first example wireless signaling operation;

FIG. 8 schematically represents a second example wireless signaling operation;

FIG. 9 schematically represents an example data transmission operation;

FIGS. 10A and 10B schematically represent a second example of the charge state of a device;

FIG. 11 shows a first example method of controlling a wireless telecommunications apparatus; and

FIG. 12 shows a second example method of controlling a wireless telecommunications apparatus.

Like reference numerals designate identical or corresponding parts throughout the drawings.

### DETAILED DESCRIPTION OF THE EMBODIMENTS

### Long Term Evolution (LTE) Wireless Communications System

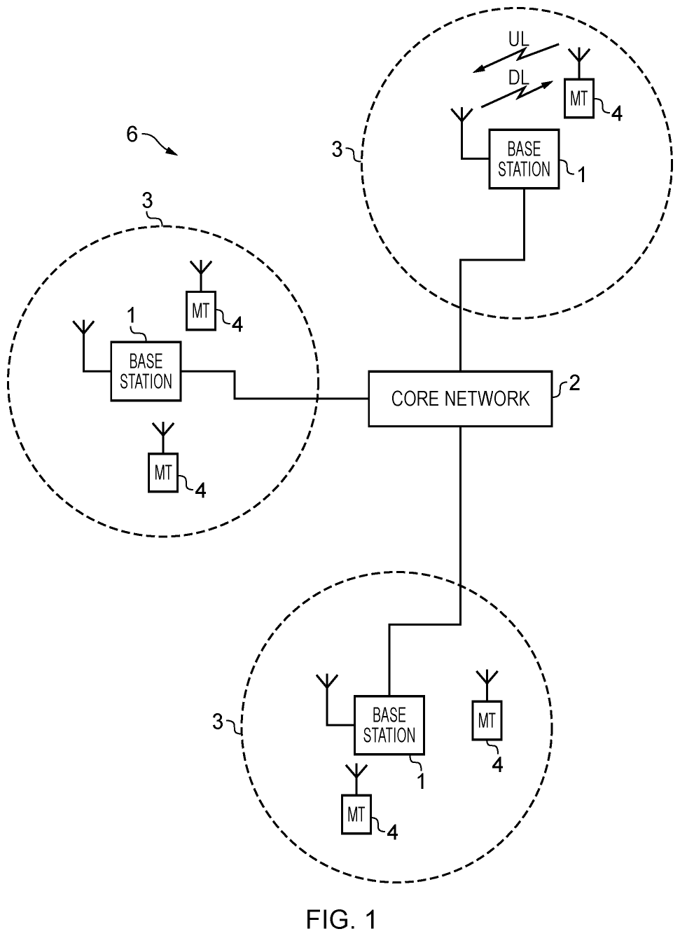

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4.

Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. A communications device may also be referred to as a mobile station, user equipment (UE), user terminal, mobile radio, terminal device and so forth.

Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

A base station which is an example of network infrastructure equipment, may also be referred to as a transceiver station, nodeB, e-nodeB, eNB, g-nodeB, gNB and so forth (note g-nodeB and gNB are related to 5G New Radio-see below). In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

In the present disclosure, any apparatus (e.g. communications device, infrastructure equipment and the like) which transmits and/or receives wireless telecommunications signals in any of the exemplified wireless telecommunication networks/systems may be referred to generally as a wireless telecommunications apparatus.

### 5G New Radio (NR) Wireless Communications System

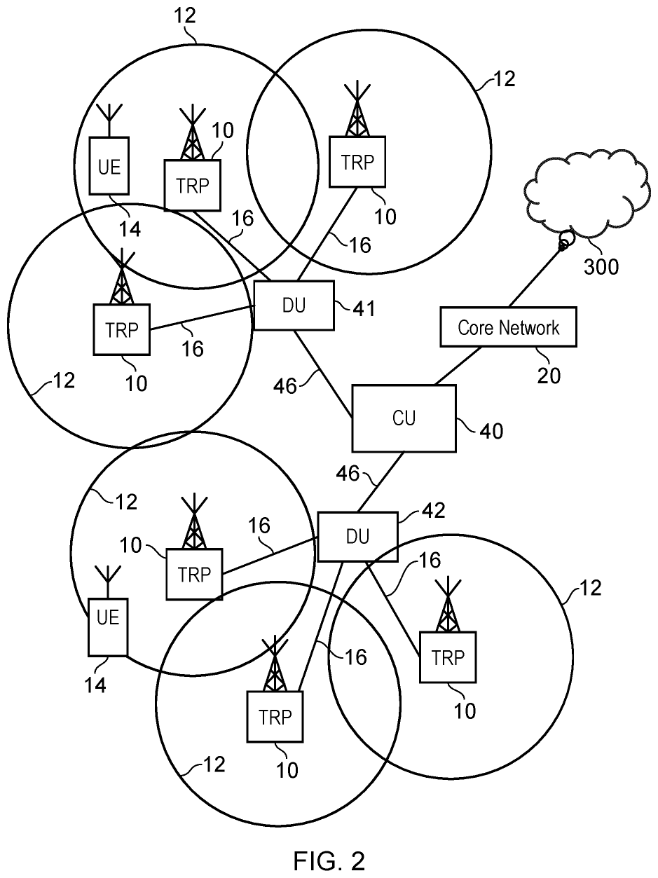

An example configuration of a wireless communications network which uses some of the terminology proposed for NR is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to a core network 20 which may contain all other functions required for communicating data to and from the wireless communications devices and the core network 20. The core network 20 may be connected to other networks 300.

The elements of the wireless access network shown in FIG. 2 may operate in a similar way to corresponding elements of an LTE network as described with regard to the example of FIG. 1. It will be appreciated that operational aspects of the telecommunications network represented in FIG. 2 and of other networks discussed herein in accordance with embodiments of the disclosure which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated, therefore, that operational aspects of an NR network (for example in relation to specific communication protocols and physical channels for communicating between different elements) may be different to those known from LTE or other known mobile telecommunications standards. However, it will also be appreciated that each of the core network component, base stations and communications devices of an NR network will be functionally similar to, respectively, the core network component, base stations and communications devices of an LTE wireless communications network.

In terms of broad top-level functionality, the core network 20 connected to the NR telecommunications system represented in FIG. 2 may be broadly considered to correspond with the core network 2 represented in FIG. 1, and the central unit 40 and associated DUs 41, 42/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the CU 40, DUs 41, 42 and/or TRPs 10. Communications devices 14 are represented in FIG. 2 within the coverage area of respective communication cells 12. These communications devices 14 may thus exchange signalling with the CU 40 via the TRP 10 associated with their respective communications cells 12.

It will further be appreciated that FIG. 2 represents merely one example of a proposed architecture for an NR-based telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a CU 40, DU 41, 42 and/or TRP 10 of the kind shown in FIG. 2 which is adapted to provide functionality in accordance with the principles described.

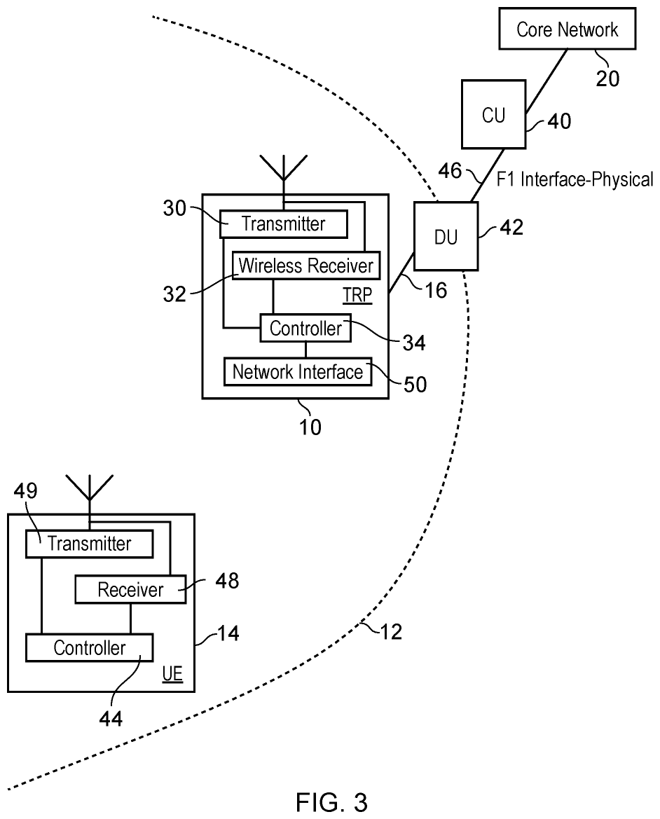

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which is configured to control the transmitter 30 and the receiver 32 to transmit radio signals to and receive radio signals from one or more UEs 14 within a cell 12 formed by the TRP 10. As shown in FIG. 3, an example UE 14 is shown to include a corresponding wireless transmitter 49, wireless receiver 48 and a controller or controlling processor 44 which is configured to control the transmitter 49 to transmit signals representing uplink data to the wireless communications network via the wireless access interface formed by the TRP 10 and the receiver 48 to receive downlink data as signals transmitted by the transmitter 30 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance, for example, with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473 and, for example, may be formed from a fibre optic or other wired high bandwidth connection. In one example, the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

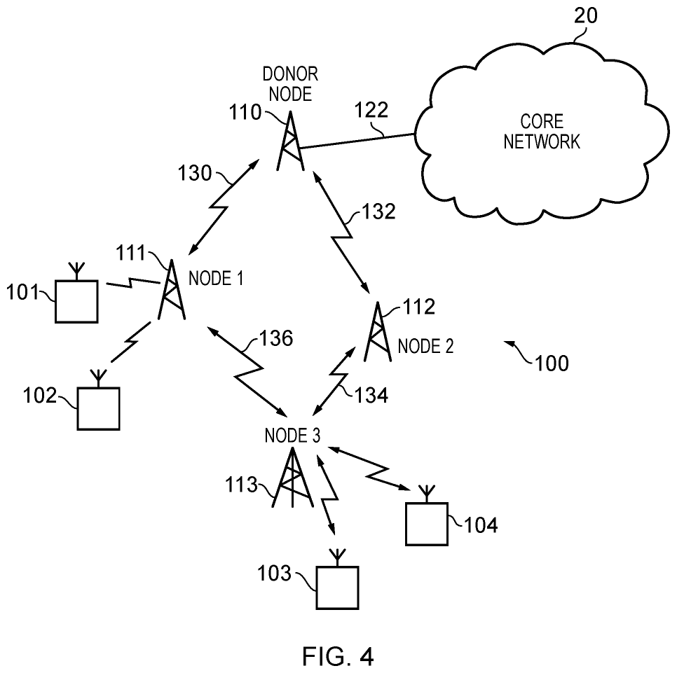

Example arrangements of the present technique can be formed from a wireless communications network corresponding to that shown in FIG. 1 or 2, as shown in FIG. 4. FIG. 4 provides an example in which cells of a wireless communications network are formed from infrastructure equipment which are provided with an Integrated Access and Backhaul (IAB) capability. The wireless communications network 100 comprises the core network 20 and a first, a second, a third and a fourth communications device (respectively 101, 102, 103 and 104) which may broadly correspond to the communications devices 4, 14 described above.

The wireless communications network 100 comprises a radio access network, comprising a first infrastructure equipment 110, a second infrastructure equipment 111, a third infrastructure equipment 112, and a fourth infrastructure equipment 113. Each of the infrastructure equipment provides a coverage area (i.e. a cell, not shown in FIG. 4) within which data can be communicated to and from the communications devices 101 to 104. For example, the fourth infrastructure equipment 113 provides a cell in which the third and fourth communications devices 103 and 104 may obtain service. Data is transmitted from the fourth infrastructure equipment 113 to the fourth communications device 104 within its respective coverage area (not shown) via a radio downlink. Data is transmitted from the fourth communications device 104 to the fourth infrastructure equipment 113 via a radio uplink.

The infrastructure equipment 110 to 113 in FIG. 4 may correspond broadly to the TRPs 10 of FIG. 2 and FIG. 3.

The first infrastructure equipment 110 in FIG. 4 is connected to the core network 20 by means of one or a series of physical connections. The first infrastructure equipment 110 may comprise a TRP 10 having the physical connection 16 to the DU 42 in combination with the DU 42 having the physical connection to the CU 40 by means of the F1 interface 46. The CU 40, in turn, is connected by means of a physical connection (e.g. fibre optic) to the core network 20.

However, there is no direct physical connection between any of the second infrastructure equipment 111, the third infrastructure equipment 112, and the fourth infrastructure equipment 113 and the core network 20. As such, it may be necessary or otherwise determined to be appropriate for data received from a communications device (i.e. uplink data) or data for transmission to a communications device (i.e. downlink data) to be transmitted to or from the core network 20 via other infrastructure equipment, such as the first infrastructure equipment 110, which has a physical connection to the core network 20, even if the communications device is not currently served by the first infrastructure equipment 110 but is, for example, in the case of the wireless communications device 104, served by the fourth infrastructure equipment 113.

The second, third and fourth infrastructure equipment 111 to 113 in FIG. 4 may each comprise a TRP, broadly similar in functionality to the TRPs 10 of FIG. 2.

In some arrangements of the present technique, one or more of the second to fourth infrastructure equipment 111 to 113 in FIG. 4 may further comprise a DU 42, and in some arrangements of the present technique, one or more of the second to fourth infrastructure equipment 110 to 113 may comprise a DU and a CU.

In some arrangements of the present technique, the CU 40 associated with the first infrastructure equipment 110 may perform the function of a CU not only in respect of the first infrastructure equipment 110, but also in respect of one or more of the second, the third and the fourth infrastructure equipment 111 to 113.

In order to provide the transmission of the uplink data or the downlink data between a communications device and the core network, a route is determined by any suitable means, with one end of the route being an infrastructure equipment physically connected to a core network and by which uplink and downlink traffic is routed to or from the core network.

In the following, the term ‘node’ is used to refer to an entity or infrastructure equipment which forms a part of a route for the transmission of the uplink data or the downlink data.

An infrastructure equipment, which is physically connected to the core network and operated in accordance with an example arrangement may provide communications resources to other infrastructure equipment and so is referred to as a ‘donor node’. An infrastructure equipment which acts as an intermediate node (i.e. one which forms a part of the route but is not acting as a donor node) is referred to as a ‘relay node’. It should be noted that although such intermediate node infrastructure equipment acts as relay nodes on the backhaul link, they may also provide service to communications devices. The relay node at the end of the route which is the infrastructure equipment controlling the cell in which the communications device is obtaining service is referred to as an ‘end node’

Hence, for clarity and conciseness in the following description, the first infrastructure equipment 110 is referred to below as the ‘donor node’, the second infrastructure equipment 111 is referred to below as ‘Node 1’, the third infrastructure equipment 112 is referred to below as ‘Node 2’ and the fourth infrastructure equipment 113 is referred to below as ‘Node 3’.

For the purposes of the present disclosure, the term ‘upstream node’ is used to refer to a node acting as a relay node or a donor node in a route which is a next hop when used for the transmission of data via that route from a wireless communications device to a core network. That is, ‘upstream node’ is used to refer to a relay node or a donor node to which uplink data is transmitted for transmission to a core network. Similarly, ‘downstream node’ is used to refer to a relay node from which uplink data is received for transmission to a core network. For example, if uplink data is transmitted via a route comprising (in order) the Node 3 113, the Node 1 111 and the donor node 110, then the donor node 110 is an upstream node with respect to the Node 1 111, and the Node 3 113 is a downstream node with respect to the Node 1 111.

More than one route may be used for the transmission of the uplink/downlink data from/to a given communications device. This is referred to as ‘multi-connectivity’. For example, the uplink data transmitted by the wireless communications device 104 may be transmitted either via the Node 3 113 and the Node 2 112 to the donor node 110, or via the Node 3 113 and the Node 1 111 to the donor node 110.

The donor node 110 and the second to fourth infrastructure equipment acting as the Nodes 1 to 3 111, 112, 113 may communicate with one or more other nodes by means of one or more inter-node wireless communications links (which may also be referred to “wireless backhaul communications links”). For example, FIG. 4 illustrates four inter-node wireless communications links 130, 132, 134, 136.

Each of the inter-node wireless communications links 130, 132, 134, 136 may be provided by means of a respective wireless access interface. Alternatively, two or more of the inter-node wireless communications links 130, 132, 134, 136 may be provided by means of a common wireless access interface and, in particular, in some arrangements of the present technique, all of the inter-node wireless communications links 130, 132, 134, 136 are provided by a shared wireless access interface.

A wireless access interface, which provides an inter-node wireless communications link, may also be used for communications between an infrastructure equipment and a communications device which is served by the infrastructure equipment. For example, the fourth wireless communications device 104 may communicate with the Node 3 113 using the wireless access interface which provides the inter-node wireless communications link 134 connecting the Node 3 113 and the Node 2 112.

The wireless access interface(s) providing the inter-node wireless communications links 130, 132, 134, 136 may operate according to any appropriate specifications and techniques.

Examples of wireless access interface standards include the 3GPP-specified General Packet Radio Service (GPRS)/Enhanced Data rates for Global Evolution (EDGE) (“2G”), Wideband Code-Division Multiple Access (WCDMA)/Universal Mobile Telecommunications System (UMTS) and related standards such as High Speed Packet Access (HSPA) and HSPA+ (“3G”), LTE and related standards including LTE-Advanced (LTE-A) (“4G”), and NR and related standards including NR-Advanced (“5G”). Techniques that may be used to provide a wireless access interface include one or more of time-division multiple access (TDMA), frequency-division multiple access (FDMA), orthogonal frequency-division multiple access (OFDMA), single-carrier frequency-division multiple access (SC-FDMA), code-division multiple access (CDMA). Duplexing (i.e. the transmission over a wireless link in two directions) may be by means of frequency division duplexing (FDD) or time division duplexing (TDD) or a combination of both.

In some arrangements of the present technique, two or more of the inter-node wireless communications links 130, 132, 134, 136 may share communications resources. This may be because two or more of the inter-node wireless communications links 130, 132, 134, 136 are provided by means of a single wireless access interface or because two or more of the inter-node wireless communications links 130, 132, 134, 136 nevertheless operate simultaneously using a common range of frequencies. The nature of the inter-node wireless communications links 130, 132, 134, 136 may depend on the architecture by which the wireless backhaul functionality is achieved.

As networks develop, there is a need to ensure entities of a network are provided with sufficient energy to communicate with the network and are able to use that energy efficiently. This is particularly true for UEs.

There are various proposals to enhance UE power saving. One of these enhancements is a “zero” power UE, where the UE can harvest energy to power its communication with the gNB. For example, the energy can be harvested from solar or kinetic energy such as vibrations.

### RF Incident Energy

Some of the proposals consider that energy is harvested from the incident radio frequency (RF) wave. Harvesting energy based on the incident RF energy has several advantages and disadvantages.

An advantage is the RF energy is always available. Hence the UE can always be awake while being powered from this energy.

A disadvantage is the received power of the RF energy source is typically low. A receiver operating on such energy typically requires a power level of −20 dBm for operation, which is not consistent with the low amounts of received power that are typically available.

Another disadvantage is the transmission power level of a device that is powered by an RF energy source is typically very low. Such devices may operate based on backscattering technology, for example. The backscattered signal is created at the same carrier frequency as the incident RF energy. It is thus hard for the source of the RF energy (e.g. a gNB) to differentiate between the transmitted RF signal and the backscattered signal.

Another disadvantage is that, to reduce the power consumption of a receiver that operates on incident RF energy, a new waveform/signaling scheme is typically required. For example, an on-off keying (OOK) signaling scheme may be used for such lower power communications. There are then issues of multiplexing this new signaling scheme with the currently supported orthogonal frequency-division multiplexing (OFDM) and SC-FDMA waveforms.

### Ambient Energy

Since there are multiple disadvantages to operating on incident RF energy, it can be desirable to operate based on ambient harvested energy. There are multiple forms of ambient harvestable energy, including solar, wind, vibration, piezoelectric, wave action, tidal action, etc.

A problem with operating on some forms of ambient energy is its unpredictability. Both the available power of ambient energy and whether the ambient energy source exists or not are unpredictable. For example, the available power of wind energy depends on the wind speed. On windless days, wind energy is not available.

Some aspects of ambient energy are predictable. For example, it is known that solar energy is available between sunrise and sunset and that the amount of solar energy depends on the elevation angle of the sun relative to the solar power harvesting device. The amount of harvestable energy may still vary however (for example, depending on cloud cover). It is also known that there are times at which this energy source is unavailable, for example during hours of darkness.

Devices can store harvested energy, for example using batteries, capacitors or supercapacitors. Energy storage technologies can be characterized by, amongst other things, the amount of charge and/or energy which is storable, the rate at which charge can be stored on the device and/or the rate at which charge can be extracted from the device.

Devices operating on ambient energy (or, for that matter, incident RF energy) can store that energy and can then use that energy to drive a modem operating with a standard waveform (such as an LTE or NR waveform). However, compared to a device operating on a conventional power source (for example, a conventional battery charged using mains electricity), the energy stored in the storage device will be rapidly depleted. The energy storage device here can be, for example, a small battery, capacitor(s) or supercapacitor(s) in which the capacity is relatively smaller than the capacity of a conventional battery. A device operating on ambient harvested energy may hence be unable to sustain a wireless connection to a network for a substantial period of time and the time for which it can sustain a connection may vary depending on conditions and the energy harvesting source. An energy storage device of the present disclosure may thus be described as a low capacity energy storage device because the amount of energy it is able to store (e.g. from ambient harvested energy) is lower than that of a conventional energy storage device charged by physically connecting the conventional energy storage device to an electricity supply (such as a mains or vehicle electricity supply).

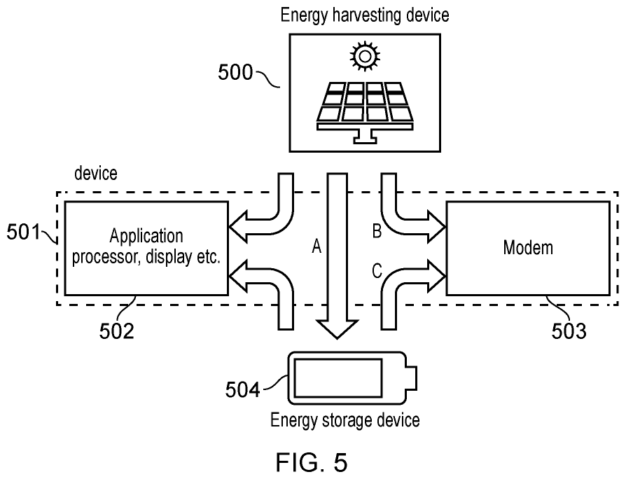

FIG. 5 shows the energy flows on a device 501 operating according to harvested energy. The device consists of a modem 503, which supports communication with a base station and other parts 502 of the device 501, which include an application processor, display, etc. An energy harvesting device 500 is connected to the device. This energy harvesting device converts ambient energy (such as solar radiation) into electrical energy. The device is also connected to an energy storage device 504, such as a small battery or large capacitor. While the energy harvesting device 500 and energy storage device 504 are shown as being separate entities to the rest of the device, in some implementations, these devices and/or any other components shown in FIG. 5 may be integrated into a single device. The device 501 may be an example of the UE 14, for example. In this case, the transmitter 49 and receiver 48 are comprised within the modem 503 and the controller 44 is comprised within the modem 503 or other parts 502, for example.

The energy harvesting device 500 generates electrical energy. This energy can be stored on the energy storage device 504 via direct transfer of energy along route “A”. The energy harvesting device can also directly power the modem 503 via route “B”. If there is a large amount of ambient power, the energy harvesting device can simultaneously power the modem (via route “B”) and store excess energy in the energy storage device (via route “A”). If there is insufficient power (for example when the modem uses a lot of power or when the energy harvesting device is generating little electrical power due to there being little ambient power), the energy storage device provides power to the modem (via route “C”). This power to the modem can be supplemented by power flowing directly from the energy harvesting device to the modem. The power flows shown in FIG. 5 can be controlled via a power management device (included in the other parts 502—in one example, when the device 501 is an example of the UE 14, the power management device may be part of the controller 44). FIG. 5 also shows that the energy harvesting device 500 and/or energy storage device 504 may also provide power to the other parts 502.

Some example values for the amount of power that can be harvested by various energy harvesting techniques are given in Table 1. This table is taken from [2]. For a solar panel with an area of 1 cm², an electrical power of approximately 10 mW could harvested, based on this table.

TABLE III
Typical energy harvesting sources and techniques used in EH-IoTs.

| Source | Transduction | Signal | Principle | Requirement | Energy Density |
|---|---|---|---|---|---|
| Kinetic | Piezoelectric | AC | Apply compression on crystalline materials | Motions or vibrations | Walking: 49 μW/cm² @ 3 km/h, |
| | Electromagnetic | AC | Change of magnetic field under movement | | piezoelectric EH, knee bending 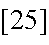 |
| | Electrostatic | AC | Change of electrical field under movement | | Wind: 370% μW/cm² @ 15 m/s, |
| | Triboelectric | AC | Frictional contact of two different materials | | triboelectric EH 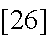 |
| Thermal | Thermoelectric | DC | Spatial temperature gradient | Temperature | 14 μW/cm² on human wrist, |
| | | | | difference | |
| | Pyroelectric | AC | Temporal temperature difference | | thermoelectric EH 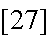 |
| Solar | Photovoltaic | DC | Convert light into electricity | Bright environment | Transparent: 7 mW/cm² @ 128 klux 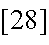 |
| | | | | | Opaque: 26.7 mW/cm² @ 128 klux 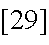 |
| | | | | | Opaque: 16 μW/cm² @ 400 lux 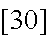 |
| RF | RF radiation | AC | Convert electromagnetic wave into electricity | Radio coverage | TV tower: 60 μW @ distance 4.1 km 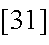 |
| | | | | | Wi-Fi: 100 μW @ distance 2 feet 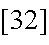 |

A problem is that, if a network communicates with device 501 without considering the intermittent and constrained characteristics of the device operating on harvested energy, a series of exchanged messages may fail as the device 501 runs out of energy before the exchange of messages has completed.

This problem can be alleviated if the gNB is aware of the device power profile and/or conditions. For example, signalling between the device 501 and a gNB and the timing of when information should be provided can be identified to alleviate this problem.

In embodiments, the device 501 reports its charge and/or energy status to the network during a connection. The network can then determine when the UE will need to harvest energy rather than perform communication with the network. In the following examples, the device 501 is a UE, which communicates with a network via a gNB. More generally, the device 501 may be any entity of a network that uses energy harvesting in the way described (e.g. a UE, relay UE, mobile node, etc.) and it may communicate with the network using any other suitable entity of the network (e.g. gNB or other infrastructure equipment, donor node, relay node, mobile node, etc.)

### UE Reports Rate of Discharging

In an embodiment, the UE reports the rate of consumption of its energy to the gNB. This gives the gNB information on how long the UE connection will last.

In an example, the UE reports the rate of energy consumption when the UE is both transmitting and receiving (full operation).

In an example, the UE reports the rate of energy consumption when the UE is transmitting (uplink). In particular, the UE may report the rate of energy consumption when the UE is transmitting at different power levels in the uplink. For example, the UE may report the rate of energy consumption when the UE is transmitting at 10 dBm and another rate of energy consumption for when the UE is transmitting at 20 dBm.

In an example, the UE reports the rate of energy consumption when the UE is receiving (downlink).

In an example, the UE reports the rate of energy consumption when the UE is performing measurements.

In an example, the UE reports the rate of energy consumption when the UE monitors for the physical downlink control channel (PDCCH) but is not scheduled with data. Note that this rate of energy consumption is generally less than the rate of energy consumption when the UE is receiving the PDCCH and the physical downlink shared channel (PDSCH) since, when the UE only receives the PDCCH, the UE can microsleep for the portion of the slot in which it is not scheduled. The gNB may therefore use this information to move the UE into a DRX state (where the UE does not need to monitor PDCCH) or it may schedule the UE in consecutive subframes to minimize the time that the UE spends in a state where it monitors for PDCCH.

In an example, the UE reports the rate of energy consumption when the UE is neither transmitting nor receiving. Even when the UE is neither transmitting nor receiving, it consumes power as it needs to maintain some internal functions when in a light sleep state.

In an example, as well as considering the rate of energy consumption due to modem operations, other components of the UE (or a device that the UE is connected to) will also consume energy and this additional energy can be considered. For instance, the UE may report the rate of energy consumption due to communications operations and separately report the rate of energy consumption due to other operations (e.g. those associated with application(s) run by the UE). Alternatively, the UE may report the combined rate of energy consumption due to communications operations and the other operations.

In an example, the UE reports the amount of charge it has at the start of the connection. Knowing this amount of charge and the rate of discharge, the gNB can estimate the remaining charge in the UE at intermediate times. The gNB can optionally request for further updates on the amount of charge (e.g. based on the gNB's scheduling) which can be used by the gNB to determine the accuracy of its estimation on the UE's remaining charge.

In the present disclosure, where the “rate of energy consumption” (e.g. in joules per second) is mentioned, it will be appreciated that other measurements could be used as a proxy for this (and these may be mentioned in other parts of the disclosure). For example, the amount of charge (e.g. in coulombs) discharged per second or the amount of energy used and/or charge discharged over a given period of time and/or to perform a given task (e.g. to transmit a message comprising a given number of bits or to monitor PDDCH in one slot) could be used.

Similarly, where the “rate of charging” (e.g. in coulombs per second) is mentioned, it will be appreciated that other measurements could be used as a proxy for this (and these may be mentioned in other parts of the disclosure). For example, the amount energy (e.g. in joules) stored per second or the amount of energy stored and/or charge accumulated over a given period of time and/or in response to a given charging event (e.g. capture of solar energy on a clear day with the sun at a given elevation over a given period of time or capture of tidal energy at a certain time of day over a given period of time) could be used.

Similarly, the terms “energy level” and “charge level” are used interchangeably when discussing the amount of energy stored in the energy storage device 504.

### UE Reports Rate of Charging

In an embodiment, if the power supply is deterministic, e.g. an Internet of Things (IoT) device operating on a vibrating machine or operating according to tidal power, the UE can report the rate of charging of its power. Based on knowledge of the rate of charging and the rate of discharging (as previously exemplified), the gNB can determine the charge state of the UE at any time.

The rate of charging may depend on the current charge state of the UE. For example, it may be possible for the UE to be charged rapidly up to 80% of its charge (e.g. at a first, greater rate of charging) and then more slowly between 80% and 100% of charge (e.g. at a second, lower rate of charging). The two different charge rates may be required to preserve the health of the energy storage device 504. In an example, the UE could thus report the following information:
For total charge stored in UE between 0% and 80%, charge rate=R₁
For total charge stored in UE between 80% and 100%, charge rate=R₂

In an example, R₁>R₂.

### UE Reports Combined Rate of Charging and Discharging

In an embodiment, the UE can both charge and discharge at the same time. In other words, for example, the energy harvesting device 500 may be generating electrical power, some of which is used to power the modem 503 and some of which is used to store charge/energy in the energy storage device 504 (so, for example, both the power flows “A” and “B” in FIG. 5 occur at the same time).

In an example, the UE signals to the gNB the rate of charging of the energy storage device when the modem is also in operation. Furthermore, separate charge rates in different situations can also be signaled.

In an example, the UE may report the charge rate when the UE is both transmitting and receiving (full operation).

In an example, the UE may report the charge rate when the UE is transmitting only (that is, uplink transmission only). In particular, the UE may report the charge rate when the UE is transmitting at different power levels in the uplink. For example, the UE may report the charge rate when the UE is transmitting at 10 dBm and another charge rate for when the UE is transmitting at 20 dBm.

In an example, the UE may report the charge rate when the UE is receiving only (that is, downlink transmission only).

In an example, the UE may report the charge rate when the UE is performing measurements.

In an example, the UE may report the charge rate when the UE monitors for the PDCCH, but the data is not scheduled. Note that this charge rate is generally greater than the charge rate when the UE is receiving PDCCH and PDSCH since, when the UE only receives PDCCH, the UE can microsleep for the portion of the slot in which it is not scheduled. When the UE is in a microsleep, the modem requires less power which means that more power can be assigned to charging the energy storage device. The gNB may use this information to move the UE into a DRX state (where the UE does not need to monitor PDCCH) or it may schedule the UE in consecutive subframes to minimize the time that the UE spends in a state where it monitors for PDCCH (again meaning the modem requires less power and so more power can be assigned to charging the energy storage device).

In an example, the UE may report the charge rate when the UE is neither transmitting nor receiving, but the UE is in a light sleep state. Even when the UE is neither transmitting nor receiving, it consumes power as it needs to maintain some internal functions when in a light sleep state. Thus, the full power from the energy harvesting device cannot be fed to the energy storage device even when the UE is in a light sleep state.

As well as reporting the charging rate, the UE may report the charge level at the start of its charge (i.e. at the start of energy harvesting) so that the gNB can estimate the time it takes for the UE to get to a specific charge level and it can schedule the UE accordingly.

In an example, the charging rate Q reported by the UE in this embodiment is the difference between the charging rate R (that is, the rate at which charge is generated by the energy harvesting device) and the aggregate discharging rate P (that is, the rate at which charge from the energy harvesting device is used to power the modem and/or other components of the UE). Thus, Q=R−P. Positive Q means the UE is generating more energy than it is using and thus can store the excess energy in the energy storage device. Negative Q means the UE is using more energy than it is generating and thus the energy storage device will be depleted of energy if the UE maintains its current operation (e.g. maintains performing communication).

### How the UE Signals the Rate of Charging/Discharging

In the above embodiments, the UE signals to the gNB rates of charging and/or discharging. This information can be signaled to the gNB in a number of ways.

In an example, the UE signals the rate of charging and/or discharging at radio resource control (RRC) connection setup. This information can be signaled in a manner according to UE capability.

In an example, during design and/or manufacture of a UE, the rates of discharge when performing various functions (e.g. those mentioned above such as receiving, transmitting, maintaining a light sleep state, etc.) are tested and recorded (e.g. as predetermined information stored on a storage medium (not shown) of the UE). The UE can hence signal this predetermined discharge information at RRC connection setup since these discharge rates are known and fixed.

In an example, a nominal charge and/or discharge rate of the UE is an estimation based on the predetermined discharge information and measured or estimated (again, based e.g. on testing during design and/or manufacture of the UE) charge information. The UE can report further rates of charging and/or discharging based on measurements during the connection either periodically or aperiodically (e.g. triggered by the gNB). The gNB can thus learn from this updated information the actual charging and/or discharge rate of the UE.

In an example, a signaled nominal charge rate is for ideal conditions and the gNB applies one or more offsets based on other information. For example, the UE can signal the charge rate of a solar panel for when the sun is directly overhead and the gNB can apply an offset to account for the actual elevation angle of the sun relative to the solar panel. The gNB will know the actual elevation angle of the sun based on the date, time of day and latitude/longitude of the solar panel (e.g. a predetermined latitude/longitude for a fixed solar panel or a latitude/longitude determined using network multilateration/multiangulation or global navigation satellite system (GNSS) coordinates for a mobile solar panel comprised as part of the UE), for example.

In an example, the gNB may learn the actual charge rate using other additional information such as meteorological observations. For example, when the UE is charged by solar energy, the ideal conditions on which the nominal charge rate is based may be for the case where the light source (e.g. the sun) is perpendicular to the solar panel on a clear day. When the device is deployed, the angle of the solar panel to the sky might be unknown or poorly calibrated. Furthermore, weather conditions will vary from day to day. The gNB may thus learn the rate at which the UE charges based on a history of the charging state of the UE in different conditions. The UE may signal this charge rate information while the gNB is learning about the rate at which the UE charges. Once the gNB has learned the rate at which the UE charges under different conditions, the UE may stop sending charge rate information to the gNB. The learning by the gNB may be implemented using one or more suitable machine learning regression and/or classification models, for example.

In an example, the charge and/or discharge rates (at least nominally) are known via subscription information. For example, the party that installs the device knows the energy harvesting device it is connected to. At connection setup, the UE signals its device identity. Once the gNB knows the device identity, it can retrieve the subscription information (including the charge and/or discharge rates) from the core network.

In a specific example, the subscription information includes information on the charge rate of the UE. The subscription information may also include other information, such as the type of energy harvesting device that powers the UE. This information may be useful for the gNB to determine the UE charge rate more accurately. For example, if the information indicates the UE is powered by wind, the gNB may determine the charge rate based on (1) the nominal charge rate of the device as indicated by the subscription information (e.g. the charge rate when the wind speed is 10 knots) and (2) the current wind speed. If the information indicates the UE is powered by solar energy, the gNB may determine the charge rate based on (1) the nominal charge rate of the device as indicated by the subscription information (e.g. the charge rate when the sun is directly overhead) and (2) the current elevation angle of the sun.

In an example, when an RRC connection is terminated, the UE reports its charge level at the end of the RRC connection. The UE can also report the charge level at the start of the UE connection and/or the expected charging and/or discharging rate once the RRC connection has been dropped. The gNB can use this information to determine how much charge the UE has used during the RRC Connection. This information can then be used to help optimize the signaling exchange during a following connection. For example, the gNB can use the reported UE charge level and charge rate after an RRC connection is dropped to determine when the gNB can set up another connection with the UE. For example, the gNB can start another connection with the UE when:

$$Charge level + charge rate * time \geq charge required for RRC connection$$

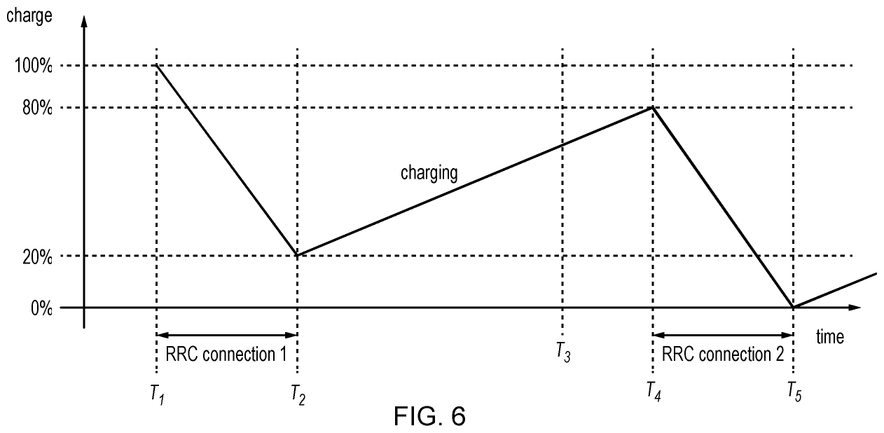

FIG. 6 shows an example of the charge state of a UE during two RRC connections. FIG. 6 shows the following:
T₁: The UE is at 100% charge state and RRC connection 1 is started. This RRC connection causes the charge level of the UE to decrease since the UE's modem is using power.
T₂: At the end of RRC connection 1, the charge level in the UE is depleted to 20%. The UE charges from the energy harvesting device following the end of the RRC connection. The UE signals that its charge level is 20% at the end of the RRC connection and also indicates its charge rate to the gNB.
T₃: The network would like to start a new RRC connection that is the same length as RRC connection 1. However, the UE used 80% of its stored charge during RRC connection 1 and the UE's energy storage device is less than 80% charged based on the reported charging rate. Since there is insufficient charge in the energy storage device, the gNB refrains from setting up a connection until the UE has reached 80% charge.
T₄: The gNB determines that the UE will have reached 80% charge, which is sufficient to support a subsequent RRC connection. This determination is based on the knowledge of charge state and charging rate that the UE indicated to the gNB at T₂. Hence, the gNB initiates RRC connection 2 with the UE.
T₅: RRC connection 2 depletes the charge level in the UE to 0%. But, the UE had sufficient energy to complete RRC connection 2.

FIG. 6 thus demonstrates how reporting the charge level and charging rate to the network allows communication between the UE and network to be completed more reliably.

In an example, the UE reports its charge level on request from the gNB. For example, when the gNB schedules the UE, it includes a message (e.g. in a medium access control (MAC) control element (CE), RRC information element (IE), downlink control information (DCI) field or wake-up signal (WUS) requesting the UE to report its charge level. In response, the UE reports its charge level in an appropriate manner. For example, a MAC CE in a PDSCH may indicate to the UE to transmit its charge level in a MAC CE within an uplink transmission. Alternatively, a MAC CE in a PDSCH may indicate to the UE to send a regular set of charge level indications within uplink control information (UCI) that are transmitted via the physical uplink control channel (PUCCH). Alternatively, the UE may receive a WUS indicating that a charge level report is required. In response, the UE can measure the UE's charge level before it monitors DCI and after it receives DCI. This allows the UE to more accurately report on the energy used in receiving DCI without, for example, having to make speculative charge level measurements before DCI is received.

In an example, the UE reports its charge level as “energy state information” (ESI). The energy state information can be transmitted in a similar manner to channel state information, for example. For example, the ESI can be transmitted as an additional field within the channel state information (CSI) or separately to the CSI channel state information. The ESI can be transmitted in an aperiodic or periodic manner. The ESI can be transmitted with the same or different periodicity as the CSI. The ESI can be configured as an extension to the current CSI signaling framework. The ESI may comprise multiple bits (and thus contain more comprehensive information) or, in one implementation, may comprise a single bit (where, for example, “0” indicates normal operation and “1” indicates the UE is moving to an energy depleted mode or is rapidly depleting energy).

In an example, the rate of charging and/or discharging is defined in multiple discrete levels, such as low, medium, high. This level can be represented (e.g. in the ESI) using one or more bits. For instance, if a two-bit system is used, a low rate of energy consumption (e.g. below a defined lower threshold) is reported as “00”, a medium rate of energy consumption (e.g. above a defined lower threshold but below a defined higher threshold) is reported as “01” and a high rate of energy consumption (e.g. above a defined higher threshold) is reported as “10”, and so on.

In an example, the charging and/or discharging rate and/or amount of charge is reported with a time-stamp. This allows the gNB to know when the measurement and/or report is performed by the UE (and thus, for example, calculate how much energy has been consumed since the measurement and/or report was performed and the current time). The time stamp may be explicitly indicated (e.g. as additional information provided with the charging, discharging and or charge amount rate information). It could also be implicit. For example, the UE may perform the measurement and/or reporting within, at or after a defined time duration known to the gNB after receiving the reporting request from the gNB.

### UE Reports its Charge Level During a Signaling Exchange

In an embodiment, the UE reports the charge level during a signaling exchange. The charge level may go up and down during such a signaling exchange. For example, the charge level will go down when the power used by the modem exceeds the power produced by the energy harvesting device and the charge level will go up when the power used by the modem is less than the power produced by the energy harvesting device (so there is excess power produced which can be used to charge the energy storage device).

In an example, the reported charge level in the device can be an absolute charge level (e.g. the number of joules/coulombs of energy stored in the energy storage device) or a relative charge level (e.g. a percentage of the total energy storage capacity of the energy storage device which is used).

In an example signaling exchange:
The UE receives DCI that schedules PDSCH for one or more subframes in the future. The UE measures the charge in the energy storage device when the UE receives the DCI (or, more particularly, just before or just after the DCI is received).
The UE receives the PDSCH that was scheduled by the DCI. At the end of PDSCH reception, the UE re-measures the charge stored in the energy storage device.
The UE transmits a PUCCH that contains hybrid automatic repeat request (HARQ) ACK/NACK information related to the PDSCH. In addition, the PUCCH contains information on the charge state of the energy storage device.

For example, the PUCCH may contain one of the following sets of information:
charge level after receiving DCI but before receiving PDSCH and charge level after receiving PDSCH (or the difference between these charge levels)
charge level before receiving DCI and charge level after receiving PDSCH (or the difference between these charge levels)

In an example, when there are multiple signals exchanged during a signaling exchange, the UE can report:
The charge level (relative or absolute) at the start of the signaling exchange.
The differences in charge level at various points in the signaling exchange. For example, when receiving DCI followed by PDSCH, the UE can report a 10% drop in charge for receiving the DCI and a further 30% drop in charge for receiving the PDSCH.

In an example, the UE can signal an increase or decrease in charge level. For example, this can be in a form that is similar to transmit power control (TPC) commands for power control. For instance, the UE can signal +1 or −1 using a one-bit signal to indicate a unit increase in charge or a unit decrease in charge, respectively (e.g. “0” indicates −1 and “1” indicates +1 or vice versa). The unit can be RRC configured or predefined (e.g. fixed in the relevant specifications). For example, it may represent a 2% increase or 2% decrease in charge. If a larger number of bits are used, the UE can indicate different units of increase and decrease. For instance, if 2 bits are used, the UE can indicate charge rates of −5%, −2%, 0% and +2% (as e.g. “00”, “01”, “10” and “11”, respectively).

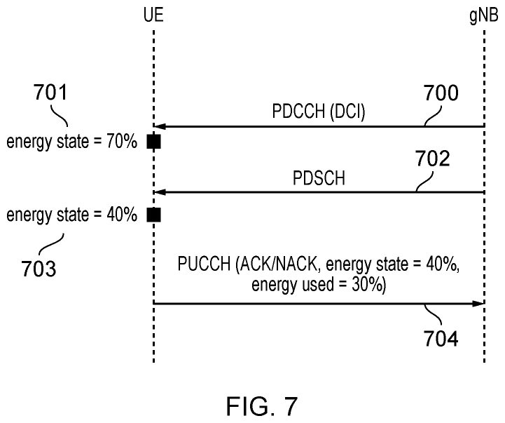

An example operation is shown in FIG. 7:
At step 700, the UE receives DCI, carried by a PDCCH. The DCI indicates that the UE should report its energy state for the rest of the signaling exchange. At step 701, as indicated by the DCI, the UE measures its energy state. The UE determines its energy storage device has 70% energy remaining.
At step 702, the UE receives PDSCH. The PDSCH reception may incur significant energy usage, since the radio may need to be on for a significant period of time and signal processing functions are required to decode the PDSCH.
At step 703, as indicated by the DCI, the UE measures its energy state after decoding the PDSCH. The UE determines its energy storage device has 40% energy remaining and thus 30% was used for PDSCH decoding.
At step 704, the UE reports in PUCCH that its energy state (prior to PUCCH transmission) is “40% remaining” and that the UE used 30% of its energy in decoding the PDSCH.

In an example, the UE measures its charge level before and after every signaling exchange. The UE then reports a history of its charge level for each signaling exchange. The UE may send this report due to various triggers. For example, the UE may be signaled to send such reports (e.g. in the DCI) or the UE may send the reports when it detects a certain condition is fulfilled. The certain condition may be that a timer has expired (e.g. so the UE reports the measured charge levels recorded whilst that timer was running). In another example, the condition may be that the charge level of the UE reaches a certain state. For instance, a threshold charge level can be set (e.g. 20%) and, once the charge level falls below this threshold, the EU transmits its charge level history. This helps the network determine how to schedule the UE in future, knowing that the UE has dwindling reserves of charge.

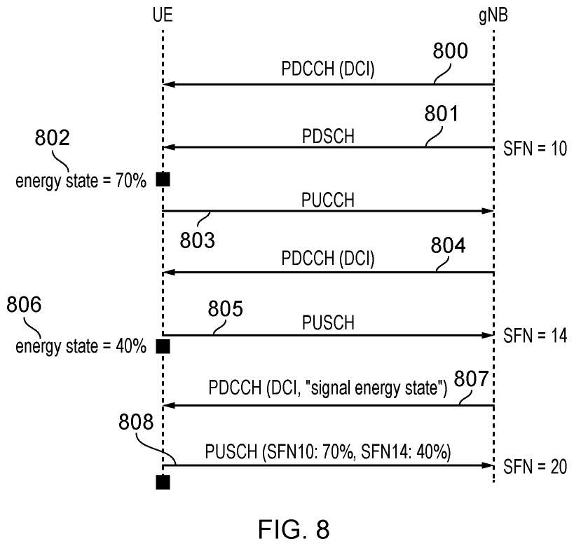

In the example of FIG. 8, PDSCH at system frame number (SFN) 10 is scheduled for the UE (by DCI carried by PDCCH) at step 800. At step 801, the PDSCH at SFN10 is decoded. At step 802, the UE determines its charge level as 70%. At step 803, the UE transmits PUCCH. PUSCH at SFN14 is scheduled for the UE (by DCI carried by PDCCH) at step 804. At step 805, PUSCH is transmitted at SFN14. At step 806, the UE determines its charge level as 40%. At step 807, the UE is signaled (by DCI carried by PDCCH) to report its energy state during the recent signaling exchange. At step 808, in response, the UE reports (via MAC CE in PUSCH scheduled for SFN20 by the DCI, in this example) that at SFN10 it had 70% energy remaining and at SFN14 it had 40% energy remaining. The gNB is then able to map the energy state of the UE to the details of the signaling exchange (e.g. the gNB can determine that the combination of {PUCCH (step 803), PDCCH (step 804), PUSCH (step 805)} between SFN10 and SFN14 consumed 30% of the UE's energy resources and that at SFN14, the UE had 40% energy remaining.

In an example, the UE reports predicted charge level at the end of a signaling exchange. For example, if the UE receives a DCI scheduling a PUSCH, the UE can include a MAC CE or UCI in the PUSCH that indicates the predicted charge level after transmitting the PUSCH. This may be particularly useful for the case that the UE is scheduled an uplink (UL) transmission. The main part of the UE power consumption will be associated with the UL transmission itself and the UE may not have the opportunity to transmit an indication of the charge level following that UL transmission. Hence, it is useful to transmit a prediction of the charge state after the UL transmission. In the example of FIG. 8, for instance, assuming the main part of the power consumption between SFN10 and SFN14 is transmitting the PUSCH at step 805 (rather than transmitting the PUCCH at step 803 or receiving the PDCCH at step 804), the UE may predict a similar level of power consumption (30%) when transmitting the PUSCH at step 808. Thus, as well as reporting the measured remaining charge levels of 70% for SFN10 and 40% for SFN14, the UE may also report (e.g. in the same MAC CE in the PUSCH of step 808) a predicted remaining charge level of 10% for SFN20 after the PUSCH in step 808 has been transmitted.

In an example, for a longer UL transmission, the UE can transmit an indication of the power consumed during an earlier part of the UL transmission. This indication can be transmitted as UCI (uplink control information) that is transmitted in PUCCH or PUSCH in a later part of the UL transmission, for example. Examples of longer UL transmissions include:
A repeated PUSCH transmission. The repetitions can be used to extend the coverage of the PUSCH. When a PUSCH is repeated, the transport bits within the PUSCH cannot change, hence transmission of charge status via UCI in the PUCCH is particularly applicable, since UCI transmission does not change the transport block carried by the PUSCH.
A multi-transport block PUSCH transmission. A single DCI can schedule multiple PUSCHs. Use of a single DCI to schedule multiple PUSCHs saves on DCI resource. Since the PUSCHs within a multi-transport block PUSCH transmission are encoded individually (a later PUSCH contains different transport bits to an earlier PUSCH), the later PUSCH can carry the charge state information within, for example, MAC CE (the set of bits within a MAC CE are part of the set of transport bits carried by a PUSCH). The charge state information can alternatively be transmitted via UCI in PUCCH in such a multi-transport block grant (MTBG) transmission.

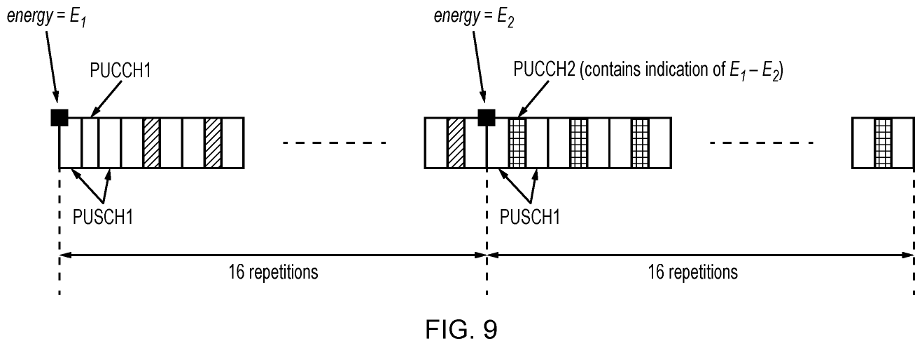

An example longer UL transmission is shown in FIG. 9. Here, a PUSCH is transmitted with 32 repetitions and the second 16 repetitions transmit a UCI/PUCCH indicating the energy/charge consumed in transmitting the first 16 PUSCH transmissions. In particular, FIG. 9 shows 32 repetitions of a PUSCH, PUSCH1. Within the 32 repetitions of PUSCH, there are separately encoded PUCCH transmissions (the PUCCH transmissions are shown as being piggybacked onto (that is, provided with or as part of) the PUSCH transmissions), PUCCH1 (transmitted with the first 16 repetitions of PUSCH1) and PUCCH2 (transmitted with the second 16 repetitions of PUSCH1). The second PUCCH transmission, PUCCH2, includes an indication of the energy, ΔE=E₁-E₂, that was used in the first 16 repetitions of PUSCH1 (the UE measuring E₁ at the start of the first 16 PUSCH1 repetitions and measuring E₂ at the end of the first 16 PUSCH1 repetitions. The gNB may then estimate an amount of energy ΔE that would also have been used for the transmission of the second 16 repetitions of PUSCH1, such that the total energy consumed energy at the end of the 32 repetitions of PUSCH1 is 2×ΔE (and thus the remaining stored energy at the end of the 32 repetitions is E₁−(2×ΔE).

In an example, the UE reports separately the increase and decrease in charge level between signaling exchanges. The increase in charge level can be due to harvested energy and the decrease in charge level can be due to the 3GPP signaling. Separate knowledge of the charge used and the charge harvested may be useful for the gNB as this information allows the gNB to calculate the charge state of the UE for different traffic patterns and for different energy harvesting conditions (e.g. accounting for the difference between day and night for solar energy harvesting).

### UE Periodically Reports its Charge Status

In an embodiment, the UE can report its energy status to the gNB periodically. For example, the gNB can configure the UE (or the UE can be preconfigured) to report its energy status to the gNB every 100 ms.

In an example, the energy status report indicates the energy/charge state of the UE. Based on the energy status of the UE and the gNB's knowledge of the signaling exchanges during the period (e.g. 100 ms), the gNB can determine, for example:
The average rate at which energy is used by the UE.
The average amount of energy used per signaling exchange with the UE. For example, if within 100 ms there were 20 signaling exchanges (e.g. signaling exchanging comprising a signal being transmitted from the gNB to the UE or vice versa) and the energy state of the UE changed by an amount ΔE′, the gNB can determine that the UE used an average ΔE′/20 units of energy per signaling exchange.

In an example, the energy status report indicates the energy/charge state of the UE for all of the events that occurred during the period. For example, if the period started at time 0 and ended at time 100 and if the UE received PDCCH at time 10, transmitted PUSCH at time 14, received PDCCH at time 40 and received PDSCH at time 46, the UE would send an energy status report consisting of “{energy at time 10, energy at time 14, energy at time 40, energy at time 46}”. The gNB can then determine the UE's energy usage for each event, based on the energy status report and the gNB's history of what it scheduled to the UE during that time.

In an example, the energy status report is transmitted via MAC CE (e.g. carried by PUSCH), UCI (e.g. carried by PUCCH) or via an RRC message.

Note that, in these examples, the UE reporting is periodic whereas, in some of the previous examples (which, for example, relied on requests for energy information being transmitted to the UE from the gNB) the UE reporting is aperiodic.

How the gNB Uses the Charging and/or Discharging Information from the UE

In an embodiment, the gNB uses the charging and/or discharging information from the UE to schedule communications with the UE.

In an example, the gNB determines whether it can transmit a set of messages to the UE before the UE runs out of energy. If the gNB estimates that the UE will not have enough energy, the gNB can signal to the UE to enter into an energy harvesting (EH) state prior to transmitting at least a portion of the messages in the set.

In an example, when the UE enters an EH state and cannot communicate with the gNB, the gNB signals to a running application of the application layer that the UE will be unavailable for a time. The gNB can also indicate to the application server the duration of time for which the UE will be unavailable.

In an example, the gNB enters a mode where it communicates with the UE periodically (e.g. according to a discontinuous reception (DRX) cycle). Operating in this mode has several advantages, for example:
When the UE does not have to communicate, it can enter into a lower power mode and harvest energy.
The periodic transmissions allow the UE to slowly communicate with the gNB. Since the application regularly receives communications from the UE, the risk of the application timing out is reduced.

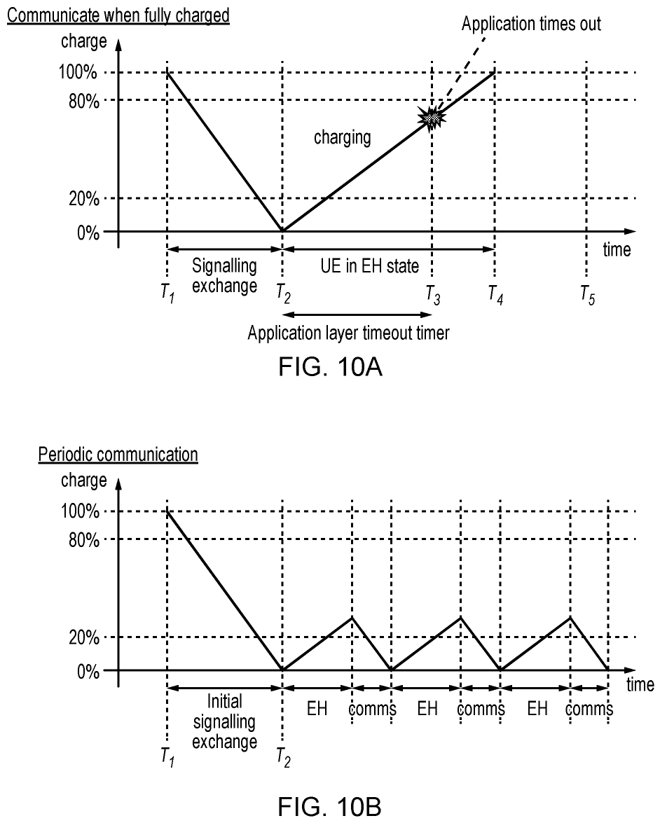

An example of this is illustrated in FIGS. 10A and 10B.

FIG. 10A shows the case where the gNB waits until the UE is fully charged before communicating with the UE again (the gNB initially communicating with the UE between T₁ and T₂ and the UE's energy storage device being completely depleted). Note that the gNB can know when the UE is fully charged based on charging rate information that is transmitted by the UE to the gNB (e.g. according to previously described embodiment(s)). A problem with waiting for the UE to fully charge, however, is that an application layer timer may timeout before the UE is fully charged. FIG. 10A shows that the UE would be fully charged at time T₄ but, at time, T₃ the application times out. This is undesirable since a new session must then be started (using yet more UE energy) and the same problem may then occur again.

A solution is shown FIG. 10B. Here, the gNB enters into periodic communication with the UE. The gNB again has an initial signaling exchange with the UE between times T₁ and T₂ (again, fully depleting the UE's energy storage device). At time T₂, the gNB enters into periodic communication with the UE. The gNB can base the timing of this periodicity (each period comprising a first “EH” time period during which the UE can harvest energy and a second, later, “comms” time period during which the UE can communicate with the gNB) based on the known charging and discharging rates of the UE (e.g. known according to previously described embodiment(s)). The UE thus periodically communicates with the gNB (and hence with the application) to avoid application timeout. In this case, the EH time period is less than the application timeout period (e.g. as indicated by T₃-T₂ in FIG. 10A).

In an example, the gNB determines whether it can quickly complete communications with the UE. For example, if the gNB determines (e.g. from ESI transmitted by the UE) that the UE is likely to run out of energy soon but that the energy required to complete the communication with the UE is less than the energy still stored in the UE, the gNB will complete the communication. In an example, the gNB may prioritise scheduling of the UE compared to other UEs (so the UE is scheduled sooner) to help ensure communications with the UE are completed whilst it still has sufficient energy.

In an example, the gNB may operate a scheduler which gives access to different UEs in a group in a rotating fashion (so once one UE in the group has been scheduled, all other UEs in the group are scheduled before the original UE is once more scheduled). Such a scheduler may not be energy efficient for a given UE as it will be “on” for a longer period of time monitoring for PDCCH compared to the case where, for example, the data is scheduled to the UE in a burst (and thus the UE can enter a low power state in which it does not decode PDCCH for the time after the burst when it knows it will not be scheduled). Knowledge of the charge and/or discharge state of a given UE in the way(s) described may allow the gNB to decide the best scheduling strategy for a given UE, thereby alleviating this problem. For example, if a given UE is about to run out of energy, the gNB may abandon the rotation scheduling for that UE and instead prioritise it over other UEs so that communication with that UE can be completed.

In an example, if the gNB determines (based on charging and/or discharging information reported by the UE) that a UE will soon run out of charge/energy, it might still communicate with the UE if there is some latency critical communication for the UE (e.g. an alarm). The energy storage device 504 associated with the UE may be damaged if charge is taken from it when the charge stored is very low. However, it might be preferable to send the latency critical communication and allow damage to the energy storage device if there are latency critical communications. Knowing the charge/discharge state of the UE will assist the gNB to make a judgement about whether to communicate with the UE or not. For example, if the gNB determines the UE to be in a very low energy state (e.g. with stored energy below a defined critical threshold), it may not communicate with the UE unless the communication is a latency critical communication. Once the UE has been able to harvest more energy (e.g. thereby taking the store energy above the critical threshold), a wider range of communication types with the UE can then be resumed.

The present disclosure thus allows UEs, in particular low power UEs, to communicate with a network more reliably. This is because the network is able to take into account the energy state of the UE when communicating with the UE. The risk of communication not being completed due to a UE's power becoming depleted during the communication is therefore reduced. Furthermore, the present disclosure is potentially usable with existing 3GPP waveforms (rather than, for example, new waveforms defined specifically for very low power devices), thereby improving interoperability with existing systems.

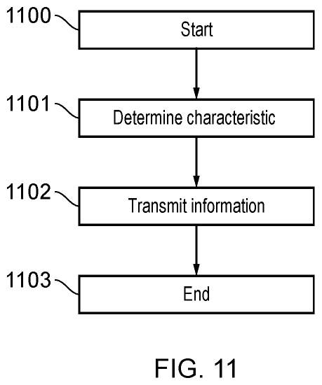

FIG. 11 shows a method carried out by a first wireless telecommunications apparatus (e.g. a UE such as device 501) according to an embodiment. The first wireless telecommunications apparatus has communication circuitry (e.g. comprised in modem 503) configured to receive wireless signals from or transmit wireless signals to a second wireless telecommunications apparatus (e.g. TRP 10, which may be a gNB), the communication circuitry using energy stored in an energy storage device (e.g. energy storage device 504) to receive or transmit the wireless signals. The first wireless telecommunications apparatus also has control circuitry (e.g. comprised in a processor of the other parts 502 or in modem 503).

The method starts at step 1100.

At step 1101, the control circuitry determines a characteristic associated with the energy stored in the energy storage device (e.g. rate of stored energy reduction, rate of stored energy increase and/or amount of energy stored).

At step 1102, the control circuitry controls the communication circuitry to transmit information indicating the determined characteristic to the second wireless telecommunications apparatus.

The method ends at step 1103.

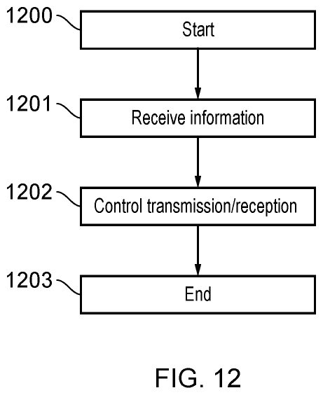

FIG. 12 shows a method carried out by a first wireless telecommunications apparatus (e.g. TRP 10, which may be a gNB) according to an embodiment. The first wireless telecommunications apparatus has communication circuitry (e.g. comprised in transmitter 30 and/or receiver 32) configured to receive wireless signals from or transmit wireless signals to a second wireless telecommunications apparatus (e.g. a UE such as device 501), the second wireless telecommunications apparatus using energy stored in an energy storage device (e.g. energy storage device 504) to receive or transmit the wireless signals. The first wireless telecommunications apparatus also has control circuitry (e.g. comprised in controller 34).

The method starts at step 1200.

At step 1201, the control circuitry controls the communication circuitry to receive, from the second wireless telecommunications apparatus, information indicating a determined characteristic associated with the energy stored in the energy storage device (e.g. rate of stored energy reduction, rate of stored energy increase and/or amount of energy stored).

At step 1202, the control circuitry controls the communication circuitry to transmit one or more wireless signals to and/or receive one or more wireless signals from the second wireless telecommunications apparatus at a timing based on the determined characteristic

The method ends at step 1203.

Embodiment(s) of the present disclosure are defined by the following numbered clauses:

1. A first wireless telecommunications apparatus comprising:
communication circuitry configured to receive wireless signals from or transmit wireless signals to a second wireless telecommunications apparatus, the communication circuitry using energy stored in an energy storage device to receive or transmit the wireless signals; and
control circuitry configured to:
determine a characteristic associated with the energy stored in the energy storage device;
control the communication circuitry to transmit information indicating the determined characteristic to the second wireless telecommunications apparatus.

2. A first wireless telecommunications apparatus according to clause 1 wherein the characteristic indicates a rate of use of energy by the first wireless telecommunications apparatus.

3. A first wireless telecommunications apparatus according to any preceding clause wherein the characteristic indicates a rate of increase of energy stored in the energy storage device.

4. A first wireless telecommunications apparatus according to any preceding clause wherein the characteristic indicates an amount of energy stored in the energy storage device.

5. A first wireless telecommunications apparatus according to any preceding clause wherein the characteristic is determined when the communication circuitry is receiving data.

6. A first wireless telecommunications apparatus according to any preceding clause wherein the characteristic is determined when the communication circuitry is transmitting data.

7. A first wireless telecommunications apparatus according to any preceding clause wherein:
the control circuitry is configured to measure a property of a wireless signal received by the communication circuitry; and
the characteristic is determined when the wireless signal is received and the property of the wireless signal is measured.

8. A first wireless telecommunications apparatus according to any preceding clause wherein:
the control circuitry is configured to monitor for a physical downlink control channel, PDCCH, in a wireless signal received by the communication circuitry; and
the characteristic is determined when the PDCCH is monitored for.

9. A first wireless telecommunications apparatus according to any one of clauses 1 to 4 wherein the characteristic is determined when the communication circuitry is neither receiving nor transmitting any wireless signal.

10. A first wireless telecommunications apparatus according to any preceding clause wherein the information indicating the determined characteristic is transmitted during radio resource control, RRC, connection setup with the second wireless telecommunications apparatus.

11. A first wireless telecommunications apparatus according to any preceding clause wherein the information indicating the determined characteristic is transmitted in response to a request received from the second wireless telecommunications apparatus.

12. A first wireless telecommunications apparatus according to any preceding clause wherein the information indicating the determined characteristic is transmitted periodically.

13. A first wireless telecommunications apparatus according to any preceding clause wherein the characteristic is determined at a plurality of times.

14. A first wireless telecommunications apparatus according to any preceding clause wherein the information indicating the determined characteristic is transmitted in a physical uplink control channel, PUCCH.

15. A first wireless telecommunications apparatus according to any preceding clause wherein the information indicating the determined characteristic is transmitted in a physical uplink shared channel, PUSCH.

16. A first wireless telecommunications apparatus according to any preceding clause wherein the characteristic is determined during a first portion of data transmission by the communication circuitry and the information indicating the determined characteristic is transmitted during a second portion of the data transmission by the communication circuitry.

17. A first wireless telecommunications apparatus according to any preceding clause wherein:
the characteristic is determined after each of one or more wireless signalling exchanges between the first and second wireless telecommunications apparatuses; and
the information indicating the determined characteristic comprises information indicating the characteristic determined after each of the one or more wireless signalling exchanges.

18. A first wireless telecommunications apparatus comprising:
communication circuitry configured to receive wireless signals from or transmit wireless signals to a second wireless telecommunications apparatus, the second wireless telecommunications apparatus using energy stored in an energy storage device to transmit or receive the wireless signals; and
control circuitry configured to:
control the communication circuitry to receive, from the second wireless telecommunications apparatus, information indicating a determined characteristic associated with the energy stored in the energy storage device;
control the communication circuitry to transmit one or more wireless signals to and/or receive one or more wireless signals from the second wireless telecommunications apparatus at a timing based on the determined characteristic.

19. A first wireless telecommunications apparatus according to clause 18 wherein the characteristic indicates a rate of use of energy by the second wireless telecommunications apparatus.

20. A first wireless telecommunications apparatus according to any one of clauses 18 to 19 wherein the characteristic indicates a rate of increase of energy stored in the energy storage device.

21. A first wireless telecommunications apparatus according to any one of clauses 18 to 20 wherein the characteristic indicates an amount of energy stored in the energy storage device.

22. A first wireless telecommunications apparatus according to any one of clauses 18 to 21 wherein the characteristic is determined when the second wireless telecommunications apparatus is receiving data.

23. A first wireless telecommunications apparatus according to any one of clauses 18 to 22 wherein the characteristic is determined when the second wireless telecommunications apparatus is transmitting data.

24. A first wireless telecommunications apparatus according to any one of clauses 18 to 23 wherein the characteristic is determined when a wireless signal is received and a property of the wireless signal is measured by the second wireless telecommunications apparatus.

25. A first wireless telecommunications apparatus according to any one of clauses 18 to 24 wherein the characteristic is determined when a physical downlink control channel, PDCCH, is monitored for in a wireless signal received by the second wireless telecommunications apparatus.

26. A first wireless telecommunications apparatus according to any one of clauses 18 to 21 wherein the characteristic is determined when the second wireless telecommunications apparatus is neither receiving nor transmitting any wireless signal.

27. A first wireless telecommunications apparatus according to any one of clauses 18 to 25 wherein the information indicating the determined characteristic is received during radio resource control, RRC, connection setup with the second wireless telecommunications apparatus.

28. A first wireless telecommunications apparatus according to any one of clauses 18 to 27 wherein the information indicating the determined characteristic is received in response to a request transmitted to the second wireless telecommunications apparatus by the communication circuitry.

29. A first wireless telecommunications apparatus according to any one of clauses 18 to 28 wherein the information indicating the determined characteristic is received periodically.

30. A first wireless telecommunications apparatus according to any one of clauses 18 to 29 wherein the characteristic is determined at a plurality of times.

31. A first wireless telecommunications apparatus according to any one of clauses 18 to 30 wherein the information indicating the determined characteristic is received in a physical uplink control channel, PUCCH.

32. A first wireless telecommunications apparatus according to any one of clauses 18 to 31 wherein the information indicating the determined characteristic is received in a physical uplink shared channel, PUSCH.

33. A first wireless telecommunications apparatus according to any one of clauses 18 to 32 wherein the characteristic is determined during a first portion of data transmission by the second wireless telecommunications apparatus and the information indicating the determined characteristic is received during a second portion of the data transmission by the second wireless telecommunications apparatus.

34. A first wireless telecommunications apparatus according to any one of clauses 18 to 33 wherein the controller is configured to:
determine, based on the determined characteristic, a time when sufficient energy is stored in the energy storage device for transmitting the one or more wireless signals to and/or receiving the one or more wireless signals from the second wireless telecommunications apparatus;
control the communication circuitry to transmit the one or more wireless signals to and/or receive the one or more wireless signals from the second wireless telecommunications apparatus at the determined time.

35. A first wireless telecommunications apparatus according to clause 34, wherein transmitting the one or more wireless signals to and/or receiving the one or more wireless signals from the second wireless telecommunications apparatus occurs represents a completed signalling exchange between the first and second wireless telecommunications apparatuses.

36. A first wireless telecommunications apparatus according to clause 35, wherein the completed signalling exchange is a completed RRC connection.

37. A first wireless telecommunications apparatus according to any one of clauses 34 to 36 wherein the determined time occurs prior to expiry of an application layer timer.

38. A first wireless telecommunications apparatus according to any one of clauses 18 to 37 wherein:
the characteristic is determined by the second wireless telecommunications apparatus after each of one or more wireless signalling exchanges between the first and second wireless telecommunications apparatuses; and
the information indicating the determined characteristic comprises information indicating the characteristic determined after each of the one or more wireless signalling exchanges.

39. A method of controlling a first wireless telecommunications apparatus, the first wireless telecommunications apparatus comprising communication circuitry configured to receive wireless signals from or transmit wireless signals to a second wireless telecommunications apparatus, the communication circuitry using energy stored in an energy storage device to receive or transmit the wireless signals, wherein the method comprises:
determining a characteristic associated with the energy stored in the energy storage device; and
controlling the communication circuitry to transmit information indicating the determined characteristic to the second wireless telecommunications apparatus.

40. A method of controlling a first wireless telecommunications apparatus, the first wireless telecommunications apparatus comprising communication circuitry configured to receive wireless signals from or transmit wireless signals to a second wireless telecommunications apparatus, the second wireless telecommunications apparatus using energy stored in an energy storage device to transmit or receive the wireless signals, wherein the method comprises:
controlling the communication circuitry to receive, from the second wireless telecommunications apparatus, information indicating a determined characteristic associated with the energy stored in the energy storage device; and
controlling the communication circuitry to transmit one or more wireless signals to and/or receive one or more wireless signals from the second wireless telecommunications apparatus at a timing based on the determined characteristic.

41. A program for controlling a computer to perform a method according to clause 39 or 40.

42. A storage medium storing a program according to clause 41.

43. A wireless telecommunications system comprising a wireless telecommunications apparatus according to clause 1 and a wireless telecommunications apparatus according to clause 18.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

### REFERENCES

[1] Holma H. and Toskala A, “LTE for UMTS OFDMA and SC-FDMA based radio access”, John Wiley and Sons, 2009.
[2] D. Ma, G. Lan, M. Hassan, W. Hu and S. K. Das, “Sensing, Computing, and Communications for Energy Harvesting IoTs: A Survey,” in IEEE Communications Surveys & Tutorials, vol. 22, no. 2, pp. 1222-1250, Secondquarter 2020

1. A first wireless telecommunications apparatus comprising:
communication circuitry configured to receive wireless signals from or transmit wireless signals to a second wireless telecommunications apparatus, the communication circuitry using energy stored in an energy storage device to receive or transmit the wireless signals; and
control circuitry configured to:
determine a characteristic associated with the energy stored in the energy storage device:
control the communication circuitry to transmit information indicating the determined characteristic to the second wireless telecommunications apparatus.

2. A first wireless telecommunications apparatus according to claim 1 wherein the characteristic indicates a rate of use of energy by the first wireless telecommunications apparatus.

3. A first wireless telecommunications apparatus according to claim 1 wherein the characteristic indicates a rate of increase of energy stored in the energy storage device.

4. A first wireless telecommunications apparatus according to claim 1 wherein the characteristic indicates an amount of energy stored in the energy storage device.

5. A first wireless telecommunications apparatus according to claim 1 wherein the characteristic is determined when the communication circuitry is receiving data.

6. A first wireless telecommunications apparatus according to claim 1 wherein the characteristic is determined when the communication circuitry is transmitting data.

7. A first wireless telecommunications apparatus according to claim 1 wherein:
the control circuitry is configured to measure a property of a wireless signal received by the communication circuitry; and
the characteristic is determined when the wireless signal is received and the property of the wireless signal is measured.

8. A first wireless telecommunications apparatus according to claim 1 wherein:
the control circuitry is configured to monitor for a physical downlink control channel, PDCCH, in a wireless signal received by the communication circuitry; and
the characteristic is determined when the PDCCH is monitored for.

9. A first wireless telecommunications apparatus according to claim 1 wherein the characteristic is determined when the communication circuitry is neither receiving nor transmitting any wireless signal.

10. A first wireless telecommunications apparatus according to claim 1 wherein the information indicating the determined characteristic is transmitted during radio resource control, RRC, connection setup with the second wireless telecommunications apparatus.

11. A first wireless telecommunications apparatus according to claim 1 wherein the information indicating the determined characteristic is transmitted in response to a request received from the second wireless telecommunications apparatus.

12. A first wireless telecommunications apparatus according to claim 1 wherein the information indicating the determined characteristic is transmitted periodically.

13. A first wireless telecommunications apparatus according to claim 1 wherein the characteristic is determined at a plurality of times.

14. A first wireless telecommunications apparatus according to claim 1 wherein the information indicating the determined characteristic is transmitted in a physical uplink control channel, PUCCH.

15. A first wireless telecommunications apparatus according to claim 1 wherein the information indicating the determined characteristic is transmitted in a physical uplink shared channel, PUSCH.

16. A first wireless telecommunications apparatus according to claim 1 wherein the characteristic is determined during a first portion of data transmission by the communication circuitry and the information indicating the determined characteristic is transmitted during a second portion of the data transmission by the communication circuitry.

17. A first wireless telecommunications apparatus according to claim 1 wherein:
the characteristic is determined after each of one or more wireless signalling exchanges between the first and second wireless telecommunications apparatuses; and
the information indicating the determined characteristic comprises information indicating the characteristic determined after each of the one or more wireless signalling exchanges.

18.-38. (canceled)

39. A method of controlling a first wireless telecommunications apparatus, the first wireless telecommunications apparatus comprising communication circuitry configured to receive wireless signals from or transmit wireless signals to a second wireless telecommunications apparatus, the communication circuitry using energy stored in an energy storage device to receive or transmit the wireless signals, wherein the method comprises:
determining a characteristic associated with the energy stored in the energy storage device; and
controlling the communication circuitry to transmit information indicating the determined characteristic to the second wireless telecommunications apparatus.

40. A method of operating a first wireless telecommunications apparatus, the first wireless telecommunications apparatus comprising communication circuitry configured to receive wireless signals from or transmit wireless signals to a second wireless telecommunications apparatus, the second wireless telecommunications apparatus using energy stored in an energy storage device to transmit or receive the wireless signals, wherein the method comprises:
controlling the communication circuitry to receive, from the second wireless telecommunications apparatus, information indicating a determined characteristic associated with the energy stored in the energy storage device; and
controlling the communication circuitry to transmit one or more wireless signals to and/or receive one or more wireless signals from the second wireless telecommunications apparatus at a timing based on the determined characteristic.

41.-43. (canceled)
